(19) United States
(12) Patent Application Publication
(10) Pub. No.: US 2023/0054281 A1
(43) Pub. Date: Feb. 23, 2023

(54) OLEOSOME COMPOSITION AND PROCESS FOR PREPARING IT

(71) Applicant: Cargill, Incorporated, Wayzata, MN (US)

(72) Inventor: Julian Carbonell, Overijse (BE)

(73) Assignee: Cargill, Incorporated, Wayzata, MN (US)

(21) Appl. No.: 17/758,712

(22) PCT Filed: Nov. 9, 2020
(86) PCT No.: PCT/US2020/059619

§ 371 Date: Jul. 13, 2022

(30) Foreign Application Priority Data
Jan. 15, 2020 (EP) 20151959.2

(51) Int. Cl. C11B 1/10; C11B 1/02; C11B 3/00; A23L 2/52

(52) U.S. Cl. CPC C11B 1/108; C11B 1/02; C11B 3/008; A23L 2/52

(57) ABSTRACT

The current invention relates to a process for in-creasing the yield of an isolated oleosome composition and the process is comprising blending of a processed fiber fraction of an oleosome source with at least one other fraction of an oleosome source. The invention relates to an isolated oleosome composition characterized in that it has a fiber content of from 0.5 to 15%, a particle size of the solids from 2 to 200 micron, and an oil content of 20 to 95% on total dry matter of which at least 60% is present as oleosomes. The invention relates to food and feed products, pharmaceutical products, personal care products, nutritional compositions and industrial products comprising the isolated oleosomes composition. The invention relates to the use of a fiber fraction of an oleosome source to increase the yield of the isolated oleosome composition.

### FIELD OF THE INVENTION

The invention relates to a process for increasing the yield of an isolated oleosome composition and the process is comprising blending of a processed fiber fraction of an oleosome source with at least one other fraction of an oleosome source. The invention also relates to an oleosome composition. The invention further relates to food and feed products, pharmaceutical products, personal care products, nutritional compositions and industrial products comprising the isolated oleosomes composition. The invention further relates to the use of a fiber fraction of an oleosome source to increase the yield of an isolated oleosome composition.

### BACKGROUND OF THE INVENTION

Oleosomes, also known as “oil bodies”, “lipid bodies”, “lipid droplets” or “spherosomes”, are pre-emulsified droplets or vesicles of oil stored in plant seeds and used as energy source for plant growth and metabolism.

Oleosomes are typically extracted from cells by a process of grinding the seeds and subsequently washing, filtering and homogenising the ground seeds to form an aqueous suspension. Said suspension is centrifuged to separate the oleosomes. The recovery rate of oleosomes in the existing extraction processes is limited and results in an oleosome composition without fibers or at least that is very low in fibers.

There is a need for increasing the yield of oleosomes obtained from oleosome sources and for an oleosome composition with an increased fiber content.

The present invention addresses this need.

### SUMMARY OF THE INVENTION

The current invention relates to a process for increasing the yield of an isolated oleosome composition and the process is comprising blending of a processed fiber fraction of an oleosome source with at least one other fraction of an oleosome source.

The invention also relates to an isolated oleosome composition characterized in that it has based on total dry matter
a fiber content of from 0.5 to 15%, and
an oil content of 20 to 95% of which at least 60% is present as oleosomes, and a particle size of the solids of from 2 to 200 micron.

The invention further relates to food and feed products, pharmaceutical products, personal care products, nutritional compositions and industrial products comprising the isolated oleosome composition of the current invention.

The invention further relates to the use of a processed fiber fraction of an oleosome source to increase the yield of an isolated oleosome composition.

### BRIEF DESCRIPTION OF THE FIGURES

FIGS. 1, 2 and 3 are specific examples of the process in accordance with the teachings of the present invention.

In each of the figures the following general legend is applied:
Products or intermediate products are coded by a capital letter (A to C), and optionally followed by a number to describe the specific sources, fractions or composition.
Arrows indicate the process flow. Arrows shown as bold/thick lines represent fixed process steps. Arrows shown as dashed lines represent optional process flows.
The performed process steps are indicated along the arrows in order of occurrence and coded with a small letter (a to j), optionally followed by a number to describe a specific process step.

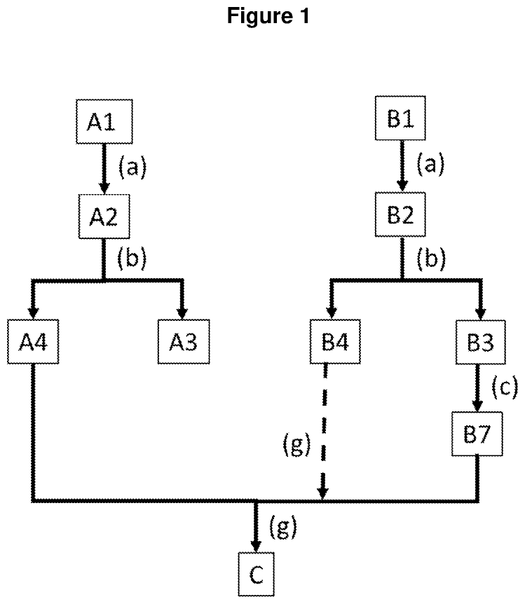

Here follows the detailed description that is adhered to in each of the FIGS. 1 to 3):
A1 and B1: an oleosome source
A2 and B2: an oleosome slurry of an oleosome source
A3 and B3: a fiber fraction of an oleosome source
A4 and B4: a fiber-reduced fraction of an oleosome source
A5 and B5: an oleosome fraction
A6 and B6: a protein fraction
A7 and B7: a processed fiber fraction
A8 and B8: a further processed oleosome fraction
A9 and B9: a further processed protein fraction
A4, A5, A6, A8, A9 and B4, B5, B6, B8, B9: the at least one other fraction of the oleosomes source (other than the processed fiber fraction)

C: isolated oleosome composition of the current invention

(a) process step for providing the oleosome slurry (A2 or B2):
(a1) dry grinding
(a2) wet grinding

(b) separation of the oleosome slurry (A2 or B2) into a fiber fraction (A3 or B3) and an at least one other fraction of the oleosome slurry:
(b1) centrifugation of the oleosome slurry (A2 or B2) into a fiber fraction (A3 or
B3) and a fiber-reduced fraction (A4 or B4);
(b2) liquid-solid-liquid separation (three-phase separation) of the oleosome slurry
(A2 or B2) into a fiber fraction (A3 or B3), an oleosome fraction (A5 or B5) and a protein fraction (A6 or B6)

(c) processing of the fiber fraction (A3 or B3):
(c1) drying of the fiber fraction (A3 or B3)
(c2) micronizing of the fiber fraction (A3 or B3)

(d) separation of the fiber-reduced fraction (A4 or B4) into an oleosome fraction (A5 or B5) and a protein fraction (A6 and B6)

(e) further processing of the oleosome fraction (A5 or B5)
(e1) UHT treatment of the oleosome fraction (A5 or B5)
(e2) spray-drying of the oleosome fraction (A5 or B5)

(f) further processing of the protein fraction (A6 or B6)
(f1) evaporation of the protein fraction (A6 or B6)
(f2) spray drying of the protein fraction (A6 or B6)

(g) blending of processed fiber fraction (A7) with the at least one other fraction of the oleosomes source such as the fiber-reduced fraction (A4 or B4), or the oleosome fraction (A5 or B5), or the protein fraction (A6 or B6), or the further processed oleosome fraction (A8 or B8), or the further processed protein fraction (A9 or B9) or any combination of two or more thereof.

(h) roasting of the one or more oleosome source A1 or B1

(i) washing of the fiber fraction (A3 or B3)

(j) mechanical de-watering of the fiber fraction (A3 or B3).

### DETAILED DESCRIPTION

The current invention relates to a process for increasing the yield of an isolated oleosome composition and the process is comprising blending of a processed fiber fraction of an oleosome source with at least one other fraction of an oleosome source.

“Oleosomes” are also known as “oil bodies”, “lipid bodies”, “lipid droplets” or “spherosomes”. and used as energy source for plant growth and metabolism. They are pre-emulsified droplets or vesicles of oil stored in cells or plant seeds.

Plant cells, fungal cells, yeast cells, bacterial cells or algae cells in which oleosomes or oleosomes-like organelles are present, are defined as an “oleosome source” is in the current invention. The terms “oleosome source” encompasses a single oleosome source as well as a combination of two or more oleosome sources.

The overall process to isolate and/or extract the oleosomes from these cells result in different fractions of the oleosome source, such as:
a fiber fraction
a processed fiber fraction
a fiber-reduced fraction
an oleosome fraction
a further processed oleosome fraction
a protein fraction
a further processed protein fraction.

The “at least one other fraction of the oleosome source” is selected from the group consisting of a fiber-reduced fraction, an oleosome fraction, a further processed oleosome fraction, a protein fraction, a further processed protein fraction or a combination of two or more thereof.

An “isolated oleosome composition” is a composition that is obtained by blending a processed fiber fraction with at least one other fraction of the oleosome source. \

According to one aspect of the invention, the process is comprising the following steps:
a) taking a processed fiber enriched oleosome fraction obtained from an oleosome slurry of an oleosome source (A),
b) taking at least one other oleosome fraction obtained from an oleosome slurry of an oleosome source (B),
c) blending the oleosome fractions of step a) and b),
d) obtaining the oleosome composition, wherein the oleosome sources (A) and (B) are the same or different.

In another aspect of the invention, the oleosome sources (A) and (B) in the process are the same.

### The Oleosome Source

In one aspect of the invention the oleosome source are cells from pollens, spores, seeds or vegetative plant organs. Preferably, the origin of the one or more oleosome source used in accordance with the invention are members of the Brassicaceae, Amaranthaceae, Asparagaceae, Echium, Glycine, Astaraceae, Fabaceae, Malvaceae, Faboidae, Aracaceae, Euphorbiceae, Sinapsis, Lamiaceae, Cyperaceae, Anacardiaceae, Rosaceae, Betulaceae, Juglandaceae, Oleaceae, Lauraceae, Sapotaceae and/or Poaceae families. More preferably, the one or more oleosome source are plant seed and most preferably plant seeds of plant species comprising: rapeseed (Brassica spp.), soybean (Glycine max), sunflower (Helianthus annuits), oil palm (Elaeis guineeis), cottonseed (Gossypium spp.), groundnut (Arachis hypogaea), coconut (Cocus nucifera), castor (Ricinus communis), safflower (Carthamus tinctorius), mustard (Brassica spp. and Sinapis alba), coriander (Coriandrum sativum), squash (Cucurbita maxima), linseed/flax (Linum usitatissimum) (including brown (also called bronze) and yellow (also called gold) linseed), Brazil nut (Bertholletia excelsa), hazelnut (Corylus avellana), walnut (Juglands major), jojoba (Simmondsia chinensis), thale cress (Arabidopsis thaliana), wheat and wheat germ (Triticum spp), maize and maize germ (Zea mays), amaranth (family of Amaranthus), sesame (Sesamum indicum), oat (Avena sativa), camelina (Camelina sativa), lupin (Lupinus), peanut (Arachis hypogaea), quinoa (Chenopodium quinoa), chia (Salvia hispanica), yucca, almond (Prunus dulcis), cashew (Anacardium occidentale), olive (Olea), avocado (Persea americana), shea (Butyrospermum parkii), cocoa bean (Theobroma cacao), argan (Argania spinosa), rice, their corresponding mid or high oleic varieties and any variety with increased level of unsaturated fatty acids compared to the original seed variety. Varieties of these seeds may be obtained by natural selection or by genetic modification (GMO).

In a particular aspect of the invention, the oleosome source may be selected from the group consisting of rapeseed and rapeseed varieties with increased level of unsaturated fatty acids compared to the original rapeseed, soybean, sunflower and corresponding mid or high oleic varieties, cottonseed, coconut, brown linseed, yellow linseed, hazelnut, maize, sesame, almond, cashew, olive, avocado and shea. The one or more oleosome source is selected from the group consisting of rapeseed, soybean, sunflower, mid and high oleic sunflower, cottonseed, coconut, brown linseed, yellow linseed, hazelnut, maize, sesame, almond, cashew and shea. More in particular, the one or more oleosome source is selected from the group consisting of rapeseed, sunflower, mid and high oleic sunflower, soybean, coconut, brown linseed, and yellow linseed. Preferably, the one or more oleosome source is sunflower, mid or high oleic sunflower.

In another aspect of the invention, the oleosome source may be subjected to a roasting process. Roasting may be applied by means of hot air at a temperature of from 110 to 145° C. for a period of from 15 to 60 minutes, from 115 to 135° C. for a period of from 20 to 45 minutes, or from 120° C. to 130° C. for a period of from 30 to 50 minutes. While roasting at a relative humidity in a range of from 10 to 30%, from 12 to 25%, or from 15 to 20% may be applied. This level of humidity may be achieved by injection of steam while roasting.

Roasting of the oleosome source may result in an improved taste and/or flavour of the fractions obtained from this roasted oleosome source in the process according to the invention, and consequently it may result in an improved taste of the oleosome composition of the present invention. The taste of such fractions obtained from an oleosome source that has not been subjected to a roasting step may be described as a more unpleasant vegetable, greenish and/or slightly bitter off taste. By subjecting the oleosome source to a roasting process, the off taste may be reduced or even removed from the fractions obtained from this roasted oleosome source. However, these fractions have substantially no or minor typical flavors associated with roasting.

### Fractions of the Oleosome Source

The processes to isolate and/or extract the oleosomes from these cells result in different fractions of the oleosome source. In a first step the oleosome source is grinded by means of wet grinding or dry grinding. An oleosome slurry is obtained, wherein components of the disrupted oleosome source are present such as oleosomes, fibers and proteins. Typically, prior to the grinding the source is cleaned and/or dehulled.

When applying dry grinding, the oleosome source is grinded using a mill such as, but not limited to, a ball-mill, a toothed colloid mill or a stone mill. Subsequently, an aqueous liquid is added in a ratio of aqueous liquid to grinded oleosome source of from 15/1 to 7/1, from 13/1 to 8/1, from 11/1 to 9/1. Afterwards, the grinded oleosome source together with the added aqueous liquid may be grinded again. In this further grinding a mill is used such as, but not limited to, a toothed colloidal mill or a corundum stone mill for obtaining one or more oleosome slurries. Optionally, the oleosome slurry may be further allowed to soak for a period of from 0.5 to 24 hours, from 1 to 16 hours, from 2 to 12 hours or from 3 to 6 hours.

Alternatively, when applying wet grinding, an aqueous liquid is added to the oleosome source in a ratio of from 15/1 to 6/1, from 12/1 to 7/1 or from 10/1 to 8/1 prior to the wet milling Optionally, the oleosome source may be allowed to soak in the added aqueous liquid for a period of from 0.5 to 48 hours, from 1 to 24 hours, from 2 to 16 hours, from 3 to 12 hours or from 4 to 8 hours. Optionally, following the period of soaking, the aqueous liquid may be removed and the oleosome source may be washed one or more times by adding fresh aqueous liquid. The oleosome source is subsequently grinded together with the added aqueous liquid. In this grinding, a mill is used such as, but not limited to, a toothed colloidal mill or a corundum stone mill. An oleosome slurry is thus obtained.

The aqueous liquid, that is used in the preparations of the oleosome slurry, is water. In one aspect of the invention the aqueous solution may be an alkaline aqueous solution with a pH of from at least 6.5 or higher, at least 7.5 or higher, at least 8.5 or higher or at least 9.5 or higher. An alkaline aqueous solution, such as, but not limited to, aqueous solution of sodium hydroxide or sodium bicarbonate, may be used.

The oleosome slurry is characterized in that it has, based on total dry matter:
a protein content of from 12 to 28%, from 15 to 25%, from 17 to 23%,
an oil content of from 55 to 70%, from 58 to 68%, from 60 to 65%, of which at least 60%, at least 70%, at least 80%, or at least 90% is contained in oleosomes, and
a fiber content of from 5 to 11%, from 6 to 10%, from 7 to 9%.

### The Fiber Fraction, Processed Fiber Fraction and the Fiber-Reduced Fraction

The oleosome slurry is separated into a fiber fraction (cake) of the oleosome source and a fiber-reduced fraction of the oleosome source. Separation may be performed by means of filtration and/or centrifugation. The fiber fraction of the oleosome source is subsequently processed, resulting in a processed fiber fraction.

The fiber fraction of the oleosome source (cake) is characterized in that it has, based on total dry matter:
a fiber content of from 12 to 30%, from 13 to 25%, or from 17 to 20%, and
a protein content of from 5 to 30%, from 10 to 25%, or from 15 to 20%,
an oil content of from 30 to 80%, from 40 to 75%, or from 50 to 70%, of which at least 60%, at least 70%, at least 80%, or at least 90% is present as oleosomes, and the solids in the fiber fraction have a particle size of the solids of at least 1000 micron, at least 800 micron, or at least 500 micron.

The processed fiber fraction of the oleosome source is obtained by milling or micronizing a fiber fraction. Alternatively, the processed fiber fraction is obtained by milling or micronizing preceded by washing and/or de-watering, and/or followed by heat-treating, dehydrating, lactic acid fermenting of the fiber fraction, or a combination of one or more thereof.

The processed fiber fraction may be obtained by milling such as wet milling, using, but not limited to, a corundum stone mill. A processed fiber fraction is obtained in the form of a paste wherein the solids have a particle size of from 40 to 200 micron, from 50 to 180 micron, from 60 to 150 micron, or from 70 to 100 micron. Optionally, the paste may be further subjected to a heat treatment; a drying step using a spray dryer or a flash dryer; or lactic acid fermentation in order to avoid microbial spoilage.

Alternatively, the processed fiber fraction of the oleosome source may be obtained by drying of the fiber fraction, followed by a micronization step. The drying step may be performed using a drum dryer, a flash dryer or the like. Micronization of the dried fiber fraction may be performed using a pin mill, a hammer mill, a mechanical classifier mill or the like. A processed fiber fraction is obtained in the form of a powder with a particle size of from 2 to 50 micron, from 4 to 40 micron, from 8 to 30, or from 10 to 25 micron.

Alternatively, the fiber fraction of the oleosome source may be simultaneously dried and micronized. This can be performed by using a rotor such as, but not limited to, a Jaeckering Rotor or a flash dryer such as, but not limited to, a Hosokawa Drymeister.

In one aspect of the invention the fiber fraction of the oleosome source is mechanically de-watered prior to drying, milling and/or micronization. Mechanical de-watering can be performed by means of, but not limited to, a filter press or a screw press. Mechanical de-watering may reduce the moisture content of the fiber fraction. This may result in an increased energy efficiency of the subsequent drying process step.

In one aspect of the invention, the fiber fraction of the oleosome source may be subjected to one, up to three, washing steps for removing remaining oleosomes, prior to processing of the fiber fraction. For each washing step, the fiber fraction is mixed with an aqueous solution. The aqueous solution may be an alkaline solution with a pH of from at least 6.5 or higher, at least 7.5 or higher, at least 8.5 or higher or at least 9.5 or higher. An alkaline aqueous solution, such as, but not limited to, aqueous solution of sodium hydroxide or sodium bicarbonate, may be used.

The thus obtained aqueous mixture is separated to obtain a washed fiber fraction of the oleosome source, and a fiber-reduced fraction of the oleosome source. Separation can be performed by means of filtration and/or centrifugation. The here mentioned “fiber-reduced fraction of the oleosome source” can likewise be used to be blended with a processed fiber fraction obtained from the oleosome sources. Alternatively, the here mentioned “fiber-reduced fraction of the oleosome source” can also be further separated into an oleosome fraction (cream) and a protein fraction (milk).

In a preferred aspect of the invention, the processed fiber fraction of the oleosome source is obtained by the consecutive steps of:
washing the fiber fraction,
optionally repeating the washing step up to two or three times, and
drying the washed fiber fraction, and
micronizing the dried fiber fraction.

This sequence of steps for obtaining the processed fiber fraction of the oleosome source may result in a fraction wherein the solids have a particle size as low as 2 micron.

Furthermore, it results in a process with a good energy efficiency.

The processed fiber fraction of the oleosome source is characterized in that it has, based on total dry matter:
a fiber content of from 12 to 30%, from 13 to 25%, or from 17 to 20%, and
a protein content of from 5 to 30%, from 10 to 25%, or from 15 to 20%,
an oil content of from 30 to 80%, from 40 to 75%, or from 50 to 70%, and the solids in the processed fiber fraction have a particle of the size of from 2 to 200 micron, from 4 to 150 micron, from 8 to 150 micron, from 10 to 100 micron, from 25 to 70, from 40 to 50 micron, from 2 to 50 micron, from 4 to 40 micron, from 8 to 30 micron, or from 10 to 25 micron.

The fiber-reduced fraction of the oleosome source is characterized in that it has based on total dry matter:
a protein content of from 10 to 35%, from 15 to 30%, from 15 to 25%,
an oil content of from 35 to 85%, from 45 to 80%, from 55 to 75%, of which at least 60%, at least 70%, at least 80%, or at least 90% is contained in oleosomes,
a fiber content of up to 4%, from up to 3%, from up to 2%.

The fiber-reduced fraction of the oleosome source may be in liquid form or powder form.

In one aspect of the invention, the fiber-reduced fraction of the oleosome source may be heat treated in order to avoid microbial spoilage. The heat treatment may be a pasteurization treatment or an ultra-high-temperature (UHT) treatment. Pasteurization treatment involves heating the at least one other oleosome fraction at a temperature of 65° C. to 70° C. for 30 minutes in batch, or 80° C. to 85° C. for 15 to 25 seconds in a continuous-flow process (High temperature short time Pasteurization (HTST)). UHT treatment involves heating of the at least one other oleosome fraction at a temperature of 135° C. to 150° C. in a continuous-flow process and holding at that temperature for one or more seconds, up to 5 seconds, before cooling rapidly to room temperature.

In another aspect of the invention, the fiber-reduced fraction of the oleosome source may be dehydrated by means of, but not limited to, spray drying or lyophilisation.

### The Oleosome Fraction and the Protein Fraction

In one aspect of the invention, the fiber-reduced fraction of the oleosome source may be further separated into an oleosome fraction (cream) and a protein fraction (milk). Separation may be performed by means of centrifugation.

Alternatively, the oleosome slurry may be subjected to a liquid-solid-liquid separation (three-phase separation) using a centrifugal tricanter. Such a separation is resulting in three fractions: the fiber fraction (cake), the oleosome fraction (cream) and the protein fraction (milk).

The oleosome fraction is characterized in that it has based on total dry matter:
a protein content of from 1.0 to 6.0%, from 1.5 to 5.0%, from 2.0 to 4.0%, and
an oil content of from 94 to 99%, from 95 to 98.5%, or from 96 to 98%, of which at least 60%, at least 70%, at least 80%, or at least 90% is present as oleosomes.

In one aspect of the invention, the oleosome fraction may be further processed by enlarging the size of the oleosomes in the oleosome fraction, by dehydrating or by heat treating the oleosome fraction, or by a combination thereof. In the process where enlarging is involved, the oleosome fraction is subjected to a further centrifugation step, or a high-shear mixing step.

The high-shear mixing step for enlarging the average globule size of the oleosomes in the oleosome fraction comprises subjecting the oleosome fraction with a dry matter content of from 40 to 80% for a period of at least 3 minutes to a high-shear mixing by means of a rotor-stator high-shear mixer with a tip velocity in a range of from 3.5 to 8.5 m/s. The tip velocity is defined as the speed of the fluid at the outside diameter of the rotor of the high-shear mixer and is expressed in meter per second (m/s).

Optionally, the oleosome fraction or the further processed oleosome fraction may be dehydrated by means of, but not limited to, spray drying or lyophilisation.

The protein fraction is characterized in that it has based on total dry matter:
a protein content of from 20 to 35%, from 23 to 33%, or from 25 to 30%, and
an oil content of from 40 to 70%, from 45 to 65%, or from 50 to 60%, of which at least 60%, at least 70%, at least 80%, or at least 90% is present as oleosomes.

In another aspect of the invention, the protein fraction may be further processed by concentrating the protein fraction by ultrafiltration and/or dehydration, and/or by heat treating the protein fraction. It may involve, but is not limited to, ultrafiltration, evaporation, spray drying, lyophilization, or combinations thereof.

The oleosome fraction, the protein fraction as well as the further processed oleosome fraction and further processed protein fraction may be in liquid form or powder form.

In one aspect of the invention, oleosome fraction, the protein fraction as well as the further processed oleosome fraction and further processed protein fraction may be heat treated in order to avoid microbial spoilage. The heat treatment may be a pasteurization treatment or an ultra-high-temperature (UHT) treatment. Pasteurization treatment involves heating the at least one other oleosome fraction at a temperature of 65° C. to 70° C. for 30 minutes in batch, or 80° C. to 85° C. for 15 to 25 seconds in a continuous-flow process (High temperature short time Pasteurization (HTST)). UHT treatment involves heating of the at least one other oleosome fraction at a temperature of 135° C. to 150° C. in a continuous-flow process and holding at that temperature for one or more seconds, up to 5 seconds, before cooling rapidly to room temperature.

In another aspect of the invention, the oleosome fraction, the protein fraction as well as the further processed oleosome fraction and further processed protein fraction of the oleosome source may be dehydrated by means of, but not limited to, spray drying or lyophilisation.

### The Isolated Oleosome Composition Obtained by the Process

At least one way to obtain the isolated oleosome composition of the present invention is by blending the processed fiber fraction of the oleosome source as is, and the at least one other oleosome fraction (other than the fiber fraction) as is, in ratio of from 10/90 to 90/10, from 15/85 to 80/20, from 20/80 to 70/30, from 25/75 to 60/40, or from 30/70 to 50/50.

The processed fiber fraction and the at least one other oleosome fraction may be from the same or a different oleosome sources.

The blending results in an isolated oleosome composition that has based on total dry matter:
a fiber content of from 1 to 15%, from 2 to 13%, from 3 to 10%, or from 4 to 8%,
an oil content of 20 to 95%, from 30 to 90%, from 40 to 80% or from 50 to 70%, of which at least 60%, at least 70%, at least 80%, or at least 90% is present as oleosomes, and

a particle size of the solids of from 2 to 200 micron, from 4 to 150 micron, from 8 to 150 micron, from 10 to 100 micron, from 25 to 70 or from 40 to 50 micron, from 2 to 50 micron, from 4 to 40 micron, from 8 to 30 micron, or from 10 to 25 micron.

Traditional existing processes may provide fiber enriched products wherein the fibers from the oleosome source have an acceptable particle size but wherein, as a result of severe processing conditions, the oleosomes are destroyed and the fat is present in the form of free oil. Consequently, the oil can freely migrate and leach from the product, and the oil is more vulnerable to oxidation, and additional emulsifiers are needed to stabilize the product.

Alternatively, there exist traditional processes that can preserve oleosomes, and thus the resulting products have the beneficial effects of oleosomes such as natural emulsifier and oil protection, but due to the processing conditions, these products contain only a minor amount of fibers.

The current invention has demonstrated that by using a processed fiber fraction of the oleosomes source, the final isolated oleosome composition has all the benefits from fibers and oleosomes all at once.

The process according to the invention allows to increase the yield of an isolated oleosome composition obtained from the oleosome source. The process according to the invention may allow to produce an isolated oleosome composition wherein not only the oleosomes are preserved but also fibers with a particle size that provides a pleasant texture and mouthfeel are present. Other nutritional components such as proteins, vitamins and micronutrients may be present. The content of the fiber is higher than fiber content in the at least one other oleosome fraction.

In one aspect of the invention, the process for increasing the yield of an isolated oleosome composition is comprising the following steps prior to blending of a processed fiber fraction of the oleosome source and an at least one other fraction of the oleosome source:
a) Providing an oleosome slurry of an oleosome source,
b) Separating the oleosome slurry into a fiber fraction of the oleosome source and a fiber-reduced fraction of the oleosome source,
c) Processing the fiber fraction of the oleosome source from step b) and obtaining the processed fiber fraction, wherein processing is milling and/or micronizing; or milling and/or micronizing preceded by washing and/or de-watering, and/or followed by heat-treating, dehydrating, lactic acid fermenting of the fiber enriched oleosome fraction, or a combination of one or more thereof, wherein the processed fiber fraction and the at least one other oleosome fraction may be from the same or a different oleosome sources.

In one aspect of the invention, the process for increasing the yield of an isolated oleosome composition is comprising the following steps prior to blending of a processed fiber fraction of the oleosome source and an at least one other fraction of the oleosome source:
a) Providing an oleosome slurry of an oleosome source,
b) Separating the oleosome slurry into a fiber fraction of the oleosome source and a fiber-reduced fraction of the oleosome source,
c) Micronizing the fiber fraction of the oleosome source from step b) and obtaining the processed fiber fraction, wherein the micronizing is preceded by washing and/or de-watering, and/or followed by heat-treating, dehydrating, lactic acid fermenting of the fiber enriched oleosome fraction or a combination of one or more thereof,
d) Separating the fiber-reduced fraction into an oleosome fraction and a protein fraction of the oleosome source,
e) Optionally further processing the oleosome fraction and obtaining an further processed oleosome fraction,
f) Optionally further processing the protein fraction and obtaining a further processed protein fraction, and
   wherein the processed fiber fraction and the at least one other oleosome fraction may be from the same or a different oleosome sources, and wherein the at least one other fraction of the oleosome source is a fiber-reduced fraction, an oleosome fraction, a further processed oleosome fraction, a protein fraction, a further processed protein fraction or a combination of two or more thereof, and wherein optionally the one or more oleosome source is roasted.

In one aspect of the invention, the process for increasing the yield of an isolated oleosome composition is comprising the following steps prior to blending of a processed fiber of the oleosome source and an at least one other fraction of the oleosome source:
a) Providing an oleosome slurry,
b) Separating the oleosome slurry into a fiber fraction and a fiber-reduced fraction of the oleosome source,
c) Micronizing the fiber enriched fraction from step b) and obtaining the processed fiber fraction, wherein the micronizing is preceded by washing and/or de-watering, and/or followed by heat-treating, dehydrating, lactic acid fermenting of the fiber fraction or a combination of one or more thereof,
d) Separating the fiber-reduced fraction of the oleosomes source into an oleosome fraction and a protein fraction,
e) Optionally further processing the oleosome fraction and obtaining a further processed oleosome fraction,
f) Optionally further processing the protein fraction and obtaining a further processed protein fraction, and
   wherein the processed fiber fraction and the at least one other oleosome fraction may be from the same or a different oleosome sources, and
   wherein the at least one other fraction of the oleosome source is a fiber-reduced fraction, an oleosome fraction, a further processed oleosome fraction, a protein fraction, a further processed protein fraction or a combination of two or more thereof, and
   wherein the oleosome source is selected from the group consisting of rapeseed, soybean, sunflower, mid and high oleic sunflower, cottonseed, coconut, brown linseed, yellow linseed, maize, sesame or a combination of two or more thereof, preferably sunflower, mid or high oleic sunflower or a combination of two or more thereof.

In one aspect of the invention, the process for increasing the yield of an isolated oleosome composition is comprising the following steps prior to blending of a processed fiber of the oleosome source and an at least one other fraction of the oleosome source:
a) Providing an oleosome slurry of an oleosome source,
b) Separating the oleosome slurry into a fiber enriched fraction and a fiber-reduced fraction of the oleosome source,
c) Micronizing the fiber fraction from step b) and obtaining the processed fiber fraction, wherein the micronizing is preceded by washing and/or de-watering, and/or followed by heat-treating, dehydrating, lactic acid fermenting of the fiber enriched oleosome fraction or a combination of one or more thereof,
d) Separating a fiber-reduced fraction of the oleosome source into an oleosome fraction and a protein fraction,
e) Optionally further processing the oleosome fraction and obtaining a further processed oleosome fraction,
f) Optionally further processing the protein fraction and obtaining a further processed protein fraction, and
   wherein
the at least one other fraction of the oleosome source is a fiber-reduced fraction, an oleosome fraction, a further processed oleosome fraction, a protein fraction, a further processed protein fraction or a combination of two or more thereof, and wherein
the oleosome source is selected from the group consisting of rapeseed, soybean, sunflower, mid and high oleic sunflower, cottonseed, coconut, brown linseed, yellow linseed, maize, sesame or a combination of two or more thereof, preferably, sunflower, mid or high oleic sunflower, or a combination of two or more thereof, and
wherein the processed fiber fraction and the at least one other oleosome fraction are from the same oleosome source, and
the oleosome source has been subjected to a roasting process.

### The Isolated Oleosome Composition According to the Invention

The invention also relates to an isolated oleosome composition characterized in that it has based on total dry matter:
a fiber content of from 1 to 15%, from 2 to 13%, from 3 to 10%, or from 4 to 8%,
an oil content of 20 to 95%, from 30 to 90%, from 40 to 80% or from 50 to 70% of which at least 60%, at least 70%, at least 80%, or at least 90% is contained in oleosomes, and
   a particle size of the solids of from 2 to 200 micron, from 4 to 150 micron, from 8 to 150 micron, from 10 to 100 micron, from 25 to 70 or from 40 to 50 micron, from 2 to 50 micron, from 4 to 40 micron, from 8 to 30 micron, or from 10 to 25 micron.

In one aspect of the invention, the oleosomes in the isolated oleosome composition have an average globule diameter of from 0.2 to 12.0 micron, from 0.5 to 10.0 micron, from 1.0 to 8.0 micron, from 1.5 to 6 micron, from 2.0 to 5.0 micron, or from 2.5 to 4 micron.

In a further aspect of the invention, the isolated oleosome composition has a protein content of at least 5%, at least 10%, at least 15%, or at least 20% based on total dry matter.

Preferably the current invention relates to an isolated sunflower oleosome composition characterized in that it has based on total dry matter:
a fiber content of from 1 to 15%, from 2 to 13%, from 3 to 10%, or from 4 to 8%,
an oil content of 20 to 95%, from 30 to 90%, from 40 to 80% or from 50 to 70% of which at least 60%, at least 70%, at least 80%, or at least 90% is contained in oleosomes, and
   a particle size of the solids of from 2 to 200 micron, from 4 to 150 micron, from 8 to 150 micron, from 10 to 100 micron, from 25 to 70 or from 40 to 50 micron, from 2 to 50 micron, from 4 to 40 micron, from 8 to 30 micron, or from 10 to 25 micron.

In the current invention, the average globule diameter of the oleosomes is expressed as the D50-value (D50). The D50-value of oleosomes is the diameter below which 50% of the volume of oleosome particles lies, and it is expressed in micron. The oleosomes are measured in diluted form of approximately 0.2% oleosomes in buffer solution of 10 mM sodium phosphate, pH 7.4, and 1% sodium dodecyl sulphate (SDS). SDS is generally used to measure real particle sizes by preventing flocculation conditions. For the purpose of the invention, the oleosomes are considered to be spherical and in case of non-spherical oleosomes, the diameter is considered as being the largest dimension that can be measured between two opposite points on the surface thereof. D50 may be determined using a Mastersizer 2000 (or 3000) from Malvern.

The invention further relates to food and feed products, pharmaceutical products, personal care products, nutritional compositions and industrial products comprising the isolated oleosome composition of the present invention.

In one aspect of the invention, the isolated oleosome composition is present in the food and feed products, pharmaceutical products, personal care products, nutritional compositions and industrial products in an amount of from 1 to 70 weight %, from 5 to 65 weight %, from 10 to 60 weight %, from 15 to 55 weight %, from 20 to 50 weight %, or from 25 to 45 weight % on total dry matter of the product.

Products containing the isolated oleosome composition may have an increased level of fibers, present in a very fine particle size and not giving an unpleasant coarse mouthfeel when eating the product. Additionally, the oil in the products containing the oleosome composition is present in the naturally emulsified form of the oleosomes. There may be no need for adding additional emulsifiers.

Examples of such food and feed products include but are not limited to, beverages such as coffee, black tea, powdered green tea, cocoa, juice etc.; oleosome composition-containing drinks, lactic acid beverages, etc.; a variety of drinks including nutrition-enriched drinks, such as calcium-fortified drinks and the like and dietary fiber-containing drinks, etc.; dairy products, such as butter, cheese, vegan cheese, yoghurt, coffee whitener, whipping cream, custard cream, custard pudding, etc.; processed fat food products, such as mayonnaise, margarine, spread, shortening, etc.; soups; stews; seasonings such as sauce, dressings, etc.; a variety of paste condiments represented by kneaded mustard; a variety of fillings typified by jam and flour paste; a variety or gel or paste-like food products including red bean-jam, jelly, and foods for swallowing impaired people; food products containing cereals as the main component, such as bread, noodles, pasta, pizza pie, corn flake, etc.; Japanese, US and European cakes, candy, cookie, biscuit, hot cake, chocolate, rice cake, etc.; kneaded marine products represented by a boiled fish cake, a fish cake, etc.; live-stock products represented by ham, sausage, hamburger steak, etc.; daily dishes such as cream croquette, paste for Chinese foods, gratin, dumpling, etc.; foods of delicate flavor, such as salted fish guts, a vegetable pickled in sake lee, etc.; liquid diets such as tube feeding liquid food, etc.; supplements; and pet foods.

Pharmaceutical products according to the invention may be formulated to include therapeutic agents, diagnostic agents and delivery agents. As a therapeutic or diagnostic agent, the product will additionally contain an active ingredient. The active ingredient can be anything that one wishes to deliver to a host. The active ingredient may be a protein or peptide that has therapeutic or diagnostic value. Such peptides include antigens (for vaccine formulations), antibodies, cytokines, blood clotting factors and growth hormones. An example of pharmaceutical product is a parenteral emulsion containing the oleosomes composition and a drug.

Personal care products according to the invention include soaps, cosmetics, skin creams, facial creams, toothpaste, lipstick, perfumes, make-up, foundation, blusher, mascara, eyeshadow, sunscreen lotions, hair conditioner, and hair coloring.

Industrial products according to the invention include paints, coatings, lubricants, films, gels, drilling fluids, paper sizing, latex, building and road construction material, inks, dyes, waxes, polishes and agrochemical formulations.

Nutritional compositions according to the invention may be compositions that are developed to cover the nutritional needs, either as a supplement, or as a complete nutrition. The people that are targeted for the nutritional composition according to the invention relate to specific groups of people, such as, but not limited to, preterm infants, infants, toddlers, invalids, elderly people, athletes or humans having nutritional deficiencies and/or having a deficient immune system. They may be designed for people suffering a more specific disease state such as cancer, chronic obstructive pulmonary disease, and later-stage kidney disease and others. Amongst others, nutritional compositions may be helpful for people who struggle with a loss of appetite, have difficulty chewing, have trouble preparing balanced meals, and/or are recovering from surgery or an illness. In the event that the nutritional composition is meant for a complete nutrition, it can provide a healthy balance of protein, carbohydrate, and/or fat.

These nutritional compositions can be in the form of liquid, as a ready-to-drink formula (such as beverage) or used in feeding tubes. It can also be in the form of a formula base i.e. a powder or a concentrated liquid, to be dissolved in water or in another fluid for the preparation of a ready-to-drink nutritional composition. The nutritional composition may also be in the form of a pudding or a jelly, or in form a cookie or a snack bar, or in any other form.

The invention further related to the use of a processed fiber fraction of an oleosome source to increase the yield of an isolated oleosome composition.

It further relates to the use wherein the isolated oleosome composition is applied to enrich the fiber content in beverages.

The current invention is illustrated by the none limiting figures.

FIG. 1 describes a specific example of the process in accordance with the teachings of the present invention, wherein an isolated oleosome composition (C) is obtained starting from two oleosome sources (A1 and B1). The oleosome sources (A1 and B1) are each grinded (a) to obtain a slurry (A2) of oleosome source (A1) and a slurry (B2) of oleosome source (B1). The oleosome slurries are each separated (b) to obtain a fiber fraction (A3) and B3) and fiber-reduced fraction (A4 and B4). The fiber fraction (B3) is processed (c) into a processed fiber fraction (B7). By blending (g) this processed fiber fraction (B7) with the fiber-reduced fraction A4 the isolated oleosome composition (C) is obtained. Optionally, fiber-reduced fraction B4 is blended (g) with the processed fiber fraction (B7) (dashed line in the figure). Optionally, fiber-reduced fraction (B4) is blended (g) with the processed fiber fraction (B7) and the fiber-reduced fraction (A4). Each of these blends provide the isolated oleosome composition (C) of the current invention. The oleosome sources (A) and (B) may be the same or different.

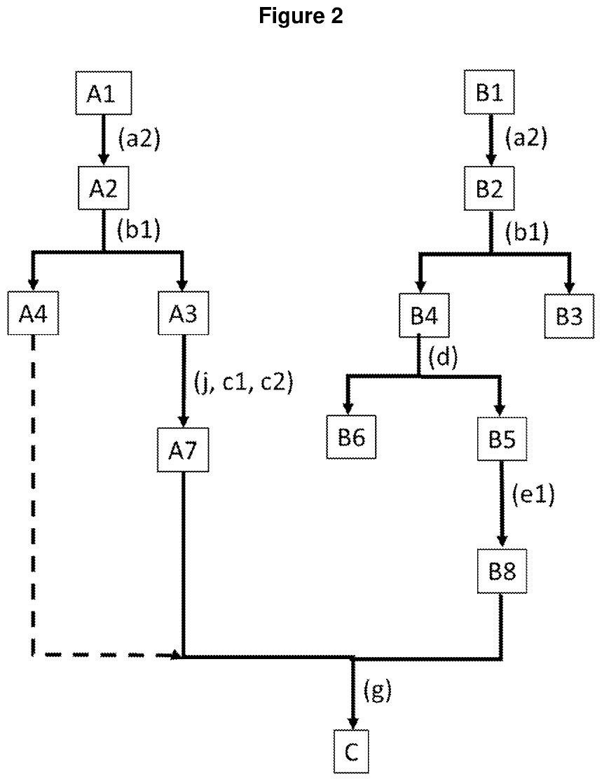

FIG. 2 describes another specific example of the process in accordance with the teachings of the present invention, wherein an isolated oleosome composition (C) is obtained starting from two oleosome sources (A1 and B1). The oleosome sources A1 and B1 are each wet grinded (a2) to obtain a slurry (A2) of oleosome source (A1) and a slurry (B2) of oleosome source (B1). The oleosome slurries are each separated by means of centrifugation (b1) to obtain a fiber fraction (A3 and B3) and a fiber-reduced fraction (A4 and B4). The fiber fraction A3 is mechanically de-watered (j), dried (c 1) and subsequently micronized (c2). A processed fiber fraction (A7) in powder form is obtained. The fiber-reduced fraction B4 is further separated (d) into an oleosome fraction (B5) and a protein fraction (B6). The oleosome fraction (B5) is further processed (e) by means of UHT treatment (el) into a further processed oleosome fraction (B8). An isolated oleosome composition (C) is obtained by blending (g) the processed fiber fraction (A7) and the further processed oleosome fraction (B8). The isolated oleosome composition (C) is obtained in liquid form. Optionally, the fiber-reduced fraction (A4) is blended (g) with the processed fiber fraction (A7) and the further processed oleosome fraction (B8). This blend also provides the isolated oleosome composition of the current invention (C).

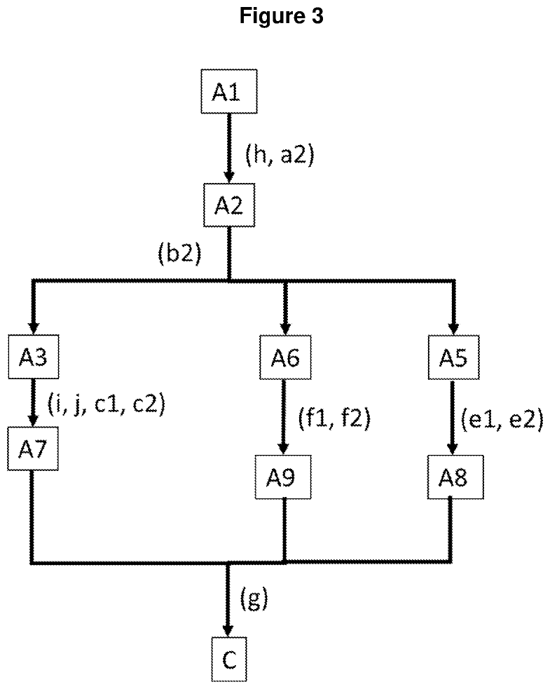

FIG. 3 describes another specific example of the process in accordance with the teachings of the present invention wherein an isolated oleosome composition (C) is obtained by starting from oleosome sources (A1). The oleosome source (A1) is roasted (h) and subsequently subjected to a wet grinding process step (a2) for obtaining a slurry (A2). The slurry (A2) is subsequently separated by means of a liquid-solid-liquid separation (three-phase separation) using a centrifugal tricanter (b2) resulting in a fiber fraction (A3), an oleosome fraction (A5) and a protein fraction (A6). The fiber fraction (A3) is washed (i), mechanically de-watered (j), dried (cl) and subsequently micronized (c2). A processed fiber fraction (A7) in powder form is obtained. The oleosome fraction (A5) is further processed (e) by applying UHT treatment (el) and spray drying (e2). A further processed oleosome fraction (A8) in powder form is obtained. The protein fraction (A6) is further processed by means of evaporation (fl) and spray drying (f2) and a further processed protein fraction (A9) is obtained. An isolated oleosome composition (C) in powder form is obtained by blending (g) the further processed fiber fraction (A7), the further processed oleosome fraction (A8) and the further processed protein fraction (A9).

1. A process for increasing the yield of an isolated oleosome composition and the process is comprising blending of a processed fiber fraction of an oleosome source with at least one other fraction of an oleosome source.

2. The process according to claim 1 and the process is comprising the following steps:
a) taking a processed fiber fraction obtained from an oleosome source (A), b) taking at least one other fraction obtained from an oleosome source (B), c) blending the oleosome fractions of step a) and b),
d) obtaining the isolated oleosome composition,
wherein the oleosome sources (A) and (B) are the same or different.

3. The process according to claim 1 wherein the oleosome sources (A) and (B) are the same.

4. The process according to claim 1 wherein the oleosome source is selected from the group consisting of rapeseed, soybean, sunflower, mid and high oleic sunflower, cottonseed, coconut, yellow linseed, brown linseed, maize, sesame or a combination of two or more thereof; preferably sunflower, mid and high oleic sunflower or a combination of two or more thereof.

5. The process according to claim 1, wherein the oleosome sources have been subjected to roasting.

6. The process according to claim 1, wherein the processed fiber fraction of the oleosome source is obtained by milling or micronizing of a fiber fraction.

7. The process according to claim 6 wherein the fiber fraction of the oleosome source is provided by separating an oleosome slurry from an oleosomes source into a fiber fraction and a fiber-reduced fraction.

8. The process according to claim 1, wherein the at least one other fraction of the oleosome source is a fiber-reduced fraction, an oleosome fraction, a protein fraction, a further processed oleosome fraction, a further processed protein fraction or a combination of two or more thereof.

9. The process according to claim 8 wherein the further processed oleosome fraction of the oleosome source is obtained by enlarging the oleosomes in the oleosome fraction, by dehydrating or by heat treating the oleosome fraction, or by a combination of two or more thereof.

10. The process according to claim 8 wherein the further processed protein fraction of the oleosome source is obtained by concentrating the protein fraction by ultrafiltration and/or dehydration, and/or by heat treating the protein fraction.

11. An isolated oleosome composition characterized in that it has based on total dry matter a fiber content of from 0.5 to 15% and an oil content of 20 to 95% of which at least 60% is present as oleosomes, and the solids of the oleosome composition have a particle size of from 2 to 200 micron.

12. Food and feed products, pharmaceutical products, personal care products, nutritional compositions and industrial products comprising the isolated oleosome composition according to claim 11.

13. The food product according to claim 12 wherein the nutritional composition in the form of a liquid.

14-15. (canceled)

16. The process according to claim 1, wherein the processed fiber fraction of the oleosome source is obtained by milling or micronizing preceded by washing and/or de-watering, and/or followed by heat-treating, dehydrating, lactic fermenting of the fiber fraction or a combination of one or more thereof.

17. The composition according to claim 11, wherein the composition has based on total dry matter: a protein content of from 10 to 35%.

18. The product according to claim 11, wherein the product comprises an amount from 1 to 70 weight % on total dry matter of the product.
